(19) United States
(12) Patent Application Publication
(10) Pub. No.: US 2010/0136168 A1
(43) Pub. Date: Jun. 3, 2010

(54) SUPPLEMENTED FRUIT OR VEGETABLE PRODUCT

(76) Inventors: Blair C. McHaney, Wenatchee, WA (US); Kevin P. Johnson, East Wenatchee, WA (US)

Correspondence Address: SEED INTELLECTUAL PROPERTY LAW GROUP PLLC, 701 FIFTH AVE, SUITE 5400, SEATTLE, WA, 98104, US

(21) Appl. No.: 12/327,696

(22) Filed: Dec. 3, 2008

(51) Int. Cl. A23L 1/212; A23L 1/30; A23L 1/302; A23L 1/303; A23L 1/304; A23L 1/305; A23B 7/10; A23B 7/155

(52) U.S. Cl. 426/52; 426/73; 426/72; 426/74; 426/615; 426/534; 426/548; 426/616; 426/617; 426/637; 426/634; 426/518; 426/321; 426/392

(57) ABSTRACT

Compositions of supplemented fruit and/or vegetable products as well as methods for making the same are provided. Certain embodiments include supplements of macronutrients and/or micronutrients. Also provided are processes of manufacture and business methods relating to the compositions disclosed.

### BACKGROUND

1. Technical Field

The present invention relates generally to processed fruit and/or vegetable products, including purees, pulps, sauces, spreads, pastes, pie fillings, or other products, and methods of making the same. Particular embodiments of the present invention are described herein.

2. Description of the Related Art

Fruit and vegetable products are generally recognized as a nutritional food for a meal or snack. In particular, fruit or vegetable purees, sauces, pulps, pastes, spreads, pie fillings or other products are useful as food for humans and animals, especially the young and old. Fruit and vegetable products are typically high in vitamins and may be low in calories. In addition, processed fruit and vegetable products typically have a long shelf-life and due to the pasteurization and/or canning. These canned or preserved products provide quick and easy access by consumers, as well as provide a staple food source in emergency situations.

Some methods of cooking or canning fruit or vegetable products diminish the fruit's nutritional value or taste. The present invention fills this void and provides other related advantages.

### DETAILED DESCRIPTION

### Definitions

For the purposes of the present invention, the terms and phrases used herein, shall have their plain and ordinary meaning as appreciated by one of skill in the art. In particular instances, we set forth the following terms to be defined as set forth herein.

“Preservative,” and any and all derivations, refers to an agent that preserves, protects, retains, or promotes the flavor, color, texture, cell wall structure, appearance, moisture, “mouth feel,” or other desirable characteristic of processed fruit or vegetable products.

Processed fruit or vegetable products, as well as any and all derivations, refers to any variety of fruit or vegetables as well as any combination of fruits or vegetables which may be any of whole or cut, pitted, cored, dehydrated, frozen, stoned and/or peeled, with inedible parts removed (seeds, pits, stones, etc.) and which have undergone cooking, pressure cooking, or general heating above about 90-120° F. The term “processed” may also include fruit or vegetable products that have been coated, filled, contacted with at least one additive, including a flavoring agent, a sweetening agent, a preservative; and/or canned or packaged.

“Organic,” and any and all derivations, refers to products whose source has been certified organic by the U.S. Department of Agriculture. (See the U.S. Department of Agriculture's website at: usda.gov).

Additives

Certain embodiments may comprise additives, such as sweeteners or sweetening agents, flavoring agents, coloring agents, macro-nutrients (protein, carbohydrate and fat levels), micro-nutrients (vitamins, minerals, etc.), thickening agents, stabilizers, and flavor enhancers. Additives may take any physical or chemical form, including but not limited to a solid, liquid, gas, gel, paste, syrup, and the like or any combination thereof that directly or indirectly contacts the fruit or vegetable and may penetrate throughout the fruit or vegetable (or be absorbed by the same).

Any of the additives disclosed herein may be diluted or directly applied to the processed fruit/vegetable product. The additive may be natural, artificial or organic. In one particular embodiment, the additive takes the form of a liquid. Such liquid form may be water-based, alcohol-based, glycerol-based, glycol-based, or fat or oil-based. In one particular embodiment, the liquid additive is heated to produce an additive vapor to which the whole fruit or vegetable and/or the processed fruit/vegetable product may be contacted.

In another particular embodiment the one or more additives are in the form of a solid. In one further embodiment, the additive is a powder, flake, ribbon, film, fiber, string, capsule, bead, microbead, tablet, pellet or shavings. In one embodiment, the additive is a tablet that may be soaked in a liquid. In another embodiment, the additive is dusted on the fruit or vegetable whole or processed product(s).

In another particular embodiment, the one or more additives are in the form of a gas, such as an atomized gas. In a further embodiment, the gas vapor is pumped onto or around the uncut fruit/vegetables or processed fruit/vegetable products.

In another embodiment, the porous or nonporous pad or surface further comprises an adhesive. In another particular embodiment, the one or more additive resides inside a crushable ampule that may or may not be edible. In another particular embodiment, the one or more additives are in the form of a gel. Such gel may include gelatin-based or polymerized glycol-based. In another particular embodiment, the additive takes the form of a paste. In another particular embodiment, the additive takes the form of an edible matrix or adhesive. One example of such edible adhesive is described in U.S. Pat. No. 5,827,553, which is hereby incorporated by reference in its entirety. In a further embodiment, the additive is in the form of a xanthan gum or carrageen base.

Other additives may include liquid media, for example fruit or vegetable juices, syrups (for example, heavy syrup or light syrup), stocks or concentrates. The liquid media may be useful in packing, and may contain additives itself (such as preservatives, flavoring agents such as spices, sweeteners, etc.).

Sweetening Agents

In certain embodiments, an additive may comprise one or more natural, artificial or organic sweeteners or sweetening agents. Such natural, artificial or organic sweeteners or sweetening agents are well known to one of skill in the art and include, but are not limited to, white cane sugar or syrup, brown sugar or syrup, dextrose, glucose, lactose, whey, ribose, xylose, xylitol, rhamnose, date sugar, white or brown rice syrup, malt, molasses or molasses powder, honey, dehydrated honey, corn syrup or corn syrup solids, maple syrup, high fructose corn syrup, fructose, saccharin, Splenda™ (sucralose), NutraSweet™ (aspartame), acesulfame-K, stevia, Shugr™ (a mixture of erythritol, maltodextrin and sucralose), any modification of these sweeteners, any combination thereof, and the like.

Flavoring Agents

In at least one embodiment, the present invention also relates to methods of flavoring a fruit or vegetable product and compositions of the same, wherein the flavoring agent(s) include, but are not limited to, apple, chocolate, rum, triple sec, peppermint, ginger, orange, lemon, lime, blueberry, blackberry, strawberry, margarita, pina colada, daiquiri, cherry, root beer, butterscotch, peanut butter, vodka, gin, whiskey, brandy, cheese, wine flavors (such as merlot, cabernet, chardonnay, etc.), smoked, barbeque, chipotle, ranch, curry, vanilla, mint, cinnamon, apple pie, raspberry, maple, grape, cola, caramel, mango, kiwi, English Toffee, cocoa, tropical flavors, bubble gum, peach, coconut, bergamot, cinnamon bark, ginger ale, grapefruit, lemon-lime, mandarin, sweet orange, triple sec, almond butter, butter pecan, coffee, cream, honey, peanut, guava, amaretto, Asian Blender, Crème de Menthe, Kalamansi, Sloe berry, Chai Tea, Tequila, white strawberry, white cranberry, ginger, white grape, guarana, jasmine, malted milk, mint, orange juice, orange sherbet, Oriental Herbal, punch, sugar, tropical fruit, Chichamorada, Cherimoya, Ginseng mint, melon, papaya, Ming Tea, Sweet Musk melon, pandan, tamarind, tangerine, strawberry kiwi, guanabana, peach apricot, Apple strudel, chocolate cherry, chocolate mint, French vanilla, licorice, minty melon, Amaretto, chocolate fudge, green bell pepper, Muscat, baby powder, Boston Crème, cantaloupe, cheesecake, chocolate hazelnut, cologne, hazelnut, pine oil, pizza, sesame oil, pumpkin spice, rose, brown sugar, sweet roll, tropical punch, vanilla cream, Bleu Cheese, melted butter, sweet butter, roasted chicken, milk chocolate, toasted coconut, ginger snap, graham cracker, mushroom, pecan, pistachio, red raspberry, blue raspberry, strudel, wafer, walnut, Royal cream, sour cream, dry apricot, caramel corn, cotton candy, cranapple, Temple orange, fresh pineapple, black raspberry, fresh strawberry, passion fruit, wildberry, orange cream, sweet cherry, banana, mango, wild raspberry, wild blueberry, wild blackberry, root beer cream, cola cream, carrot, carrot cake, pumpkin, “buttery” versions of any flavors described herein, any flavors described herein with cinnamon or extra cinnamon or other spice, or any combination thereof.

As one of skill in the art would recognize, flavoring agents may be obtained from any number of producers or manufacturers. In some circumstances, the exact chemical formulation for the flavoring agent may be proprietary. In other circumstances, the exact chemical formulation may be known or obtainable. Some examples of flavorings for which the chemical formula is known include benzaldehyde (C₆H₅CHO) and benzyl chloride (C₇H₇Cl).

In at least one embodiment, the flavoring agent and/or preservative is not methyl anthranilate (also referred to as methyl-o-aminobenzoate, neroli oil, or 2-Aminobensoic acid methyl ester).

Coloring Agents

The colors or coloring agents used herein for the fruit or vegetable products include natural or artificial colors. In one embodiment, the coloring agents are of edible food grade dye. In another particular embodiment, the coloring agents are not edible and are used as fruit or vegetable product decorations. Some coloring agents which may be used with the present invention include Red, Pink, Gray, Orange, Yellow, Green, Blue, White, Indigo, Violet (Purple), Black, fluorescent or neon versions of any color, shades, tones or tints of any color, and any combinations of colors.

As one of skill in the art will recognize, the colorant may take any particular form, including solid, liquid, gas, gel, paste, or any other form disclosed herein. In addition, one of skill in the art would recognize that colorants may be water-soluble dyes or pigments; an aluminum lake pigment that may be dispersed in oils, fats, or other carriers such as propylene glycol, glycerin or a sucrose suspension; oil-soluble dyes or pigments, as well as others, or any combination thereof. The colorants of the present invention may be natural, artificial, organic, inorganic, or any combination thereof.

Some examples of “natural” colorants that may or may not be edible include beet, paprika, annatto, tumeric, cabbage, caramel, and others. Some examples of pigments that are not edible include azo dyes, phthalocyanine, quinacridone, molybdate orange, chromium yellow, chromocyanine green, mica, iron oxide, titanium dioxide, and others.

More specifically, some edible colorants include, but are not limited to, Food, Drug & Cosmetic (FD&C) Blue 1, FD&C Green 3, FD&C Yellow 3, FD&C Yellow 4, FD&C Yellow 5, FD& C Yellow 1, FD&C Yellow 10, FD&C Yellow 6, FD&C Red 7, FD&C Blue 2, FD&C Red 3, FD&C Red 2, FD&C Red 14, FD& C Red 40, FD&C Red 4, FD&C Red 9, FD&C Red 22, FD&C Red 28, FD&C Yellow 13, FD&C Blue 1, FD&C Brown 2, FD&C Blue 5, FD&C Brown 3, FD&C Green 5, FD&C Green 6, FD&C Red 17, FD&C Blue 15, FD&C Green 4, FD&C Black 1, and any combination thereof.

Some colorants that may be used with the present invention but are inedible include, but are not limited to, Drug and Cosmetic (D&C) Green 5, D&C Green 6, D&C Green 8, D&C Red 28, D&C Red 30, D&C Red 33, D&C Yellow 10, and any combination thereof.

Preservatives

As disclosed herein for other additives, the preservatives may take any form of solid, liquid, gas, or any combination or mixture thereof. If the preservative is in the form of a liquid, such liquid may be water-based, alcohol based, glycerol based, glycol-based, or fat or oil-based. If the preservative is in the form of a solid, it may be a powder, flake, ribbon, film, fiber, string, capsule, bead, microbead, tablet, pellet or shavings, for example.

Some preservatives that may be used with certain embodiments include, but are not limited to, citric acid; NatureSeal™ (for example, as described in U.S. Pat. No. 5,925,395, which is hereby incorporated by reference); vitamin(s); mineral(s); ascorbic acid; potassium sorbate; enzymes; acids; bases; erythorbic acid; calcium; sulfur dioxide; sulfites; benzoic acid; Freshxtend™ (a proprietary blend of vitamins and minerals, including vitamin C and calcium chloride that is available from Fortitech, Inc.) other antioxidants such as butylated hydroxyanisole (BHA), butylated hydroxytoluene (BHT), tert-butylhydroquinone (TBHQ), propyl gallate, ascorbyl palmitate; or any combination thereof. Further examples of preservatives that may be used with the present invention include those described in U.S. Pat. No. 5,939,117, which is hereby incorporated by reference in its entirety.

In addition to any preservative qualities achieved by adding vitamins and/or minerals, at least one vitamin and/or mineral may be added to the fruit or vegetable products for additional nutritional value. Any added vitamin(s) and/or mineral(s) may take any form herein described (e.g. solid, liquid, gas, gel, etc.), and may be applied by any mode described herein for the same (spraying, immersing, etc.).

Micronutrients and Macronutrients

Some examples of vitamins and/or minerals (also referred to as “micronutrients”) that may be added to the fruit or vegetable products for additional nutritional value (as well as for any flavoring, anti-browning or other beneficial characteristics) include the following, which may be known in the art by several different names: vitamin A (carotene, retinol, beta-carotene), vitamin B1 (thiamine), vitamin B2 (riboflavin), vitamin B3 (nicotinic acid, niacin, vitamin PP), vitamin B5 (calcium pantothenate, pantothenic acid), vitamin B6 (pyridoxine, pyridoxamine), vitamin B7 (choline), inositol, vitamin B8 (coenzyme R), vitamin H (biotin), vitamin B9 (vitamin M, folic acid, folacin), vitamin B10 (para-aminobenzoic acid or PABA), vitamin B12 (cobalamin, cyanocobalamin), vitamin B13 (orotic acid), vitamin B15 (pangamic acid), vitamin B17 (laetrile), vitamin C (ascorbic acid), vitamin P (C-complex, citrus bioflavonoid, rutin, hesperidin), vitamin D (calciforol), vitamin E (tocopherol), vitamin K (menadione), chromium, copper, fluorine, manganese, lycopene, lutein, selenium, zinc, calcium, chlorine, magnesium, phosphorus, potassium, sodium, sulfur, cobalt, iodine, iron, molybdenum, bismuth, boron, nickel, rubidium, silicon, strontium, tellurium, titanium, tin, tungsten, vanadium, and others.

Macronutrients (nutrients of which the body requires relatively large amounts) may be added to the fruit segments as well. Exemplary macronutrients include but are not limited to: carbohydrates, fiber, fat, fatty acids, cholesterol, protein, amino acids, and water. If macronutrients (especially protein and/or fat) are added to the fruit segments, they may be derived from plant matter (such as soy, seaweed or nuts), from animal matter (such as meat, dairy or egg products), or from another source (plankton, fungus, cyanobacteria, other microorganisms, etc.). Some examples of fatty acids that may be introduced to or incorporated in the fruit segments include saturated fatty acids, which do not contain any double bonds or other functional groups along the chain (such as butyric, caproic, caprylic, capric, lauric, myristic, palmitic, steric, arachidic, behenic, and others), unsaturated fatty acids, which contain one or more alkenyl functional group along the chain and be monounsaturated or polyunsaturated, cis or trans. Some examples of unsaturated fatty acids include omega 9 fatty acids (such as oleic acid, and erucic acid), omega 6 fatty acids (such as linoleic acid, and arachidonic acid), and omega 3 fatty acids (such as alpha-linelenic, eicosapentaenoic acid, docosahexaenoic acid) and others. Various types of fatty acids may come from any number of sources, including plant or animal products such as corn, soy, flax, rice, barley, fish, seaweed, wheat, oat, or other oil sources.

Some examples of carbohydrates include monosaccharides, such as glucose, galactose and fructose, and polysaccharides, such as starch, glycogen, or cellulose. In addition, carbohydrates may contain one or more modified monosaccharide units that have one or more groups replaced or removed. For example, deoxyribose is a modified version of ribose.

Flavor Enhancers

In one particular embodiment, the additive further comprises at least one flavor enhancer. Flavor enhancers are well known to one of skill in the art and include, but are not limited to, natural or artificial sweeteners, monosodium glutamate (MSG), disodium glutamate (DSG), inosine 5′monophosphate (IMP), guanosine 5′monophosphate (GMP), D-tagatose, any combination thereof, or the like. Flavor enhancers may also function as preservatives, in some embodiments.

Types of Fruits or Vegetables

In particular embodiments of the present invention, the processed product may relate to any fruit or vegetable capable of being processed and may include or exclude any specific fruit or vegetable listed herein: apples, pears, Asian pears, cherries, strawberries, plums, peaches, nectarines, grapes, melons (including watermelon, cantaloupe, honey dew melon, muskmelon, etc.), guava, dates, figs, apricots, kiwi, citrus fruit (including lemons, limes, grapefruit, oranges, tangelos, kumquats, ugli fruit, mandarin oranges, Satsuma oranges, etc.), mango, bananas, passion fruit, pineapple, cranberries, blueberries, blackberries, papaya, coconut, jackfruit, tomatoes, leafy vegetables (also called potherbs, greens, or leafy greens and include lettuce, spinach, Swiss chard, clover, grasses such as wheat, barley and alfalfa), stem vegetables (including asparagus), root vegetables (including tuberous roots, taproots, tubers, rhizomes, corms, and bulbs); some examples of true root vegetables include celeriac, burdock or gobo, arracacha, beet and mangelwurzel, rutabaga, turnip, black cumin, carrot, maca, jicama and ahipa, parsnip, parsley root, daikon and radish, black salsify, skirret, salsify, earthnut, sweet potato, cassava, mauka or chago, breadroot, tipsin, or prairie turnip, yacon, konjac, taro, Chinese water chestnut, enset, katakuri, arrowhead or wapatoo, malanga, cocoyam, tannia, rengarenga, vanilla lily, canna, ti, arrowroot, lotus root, cattail or bulrush, hog potato or groundnut, tigernut or chufa, yams, ube, daylily, artichoke, artichoke hearts, Jerusalem artichoke or sunchoke, earthnut pea, oca or New Zealand yam, potato, kembili, dazo, Chinese artichoke or crosne, mashua or anu, ulluco, bulibs (garlic, onion, shallot), mushrooms, quamash, seeds (peas, beans), flowers (broccoli), botanical fruits (cucumbers, squash, pumpkins, capsicums), culinary fruits (nuts, grains, herbs), Brussels sprouts, pumpkins, squash, cabbage, cauliflower, kale, rapini, kai-lan, bok choy, komatsuna, mizuna greens, oriental mustard, amaranth, arugula, bitterleaf, catsear, celtuce, Ceylon spinach, chicory, Chinese mallow, chrysanthemum, corn salad, cress, dandelion, endive, epazote, fat hen, fiddlehead, fluted pumpkin, golden samphire, Good King Henry, Iceplant, Kuka, lagos bologi, land cress, Lizard's tail, Melokhia, mustard, New Zealand spinach, orache, radicchio, samphire, sea beet, seakale, Sierra Leone bologi, soko, sorrel, summer purslane, watercress, water spinach, winter purslane, Armenian cucumber, eggplant, avocado, caigua, cayenne pepper, chayote, chile pepper, courgette, globe artichoke, luffa, Malabar gourd, marrow, parwal, snake gourd, sweetcorn, tinda, West Indian gherkin, zucchini, black-eyed pea, chickpea, dolichos bean, fava bean, guar, horsegram, lentil, lima bean, moth bean, mung bean, okra, peanut, pigeon pea, rice bean, soybean, cardoon, celery, Florence fennel, kohlrabi, leek, Prussian asparagus, Welsh onion, wild leek, bamboo shoot, ginger, rutabaga, chokeberry, hawthorn, serviceberry, loquat, medlar, quince, rowan, rose-hip, shipova, apricot, cherry, plum, peach, nectarine, blackberry, boysenberry, loganberry, cloudberry, wineberry, salmonberry, thimbleberry, bearberry, bilberry, crowberry, huckleberry, lingonberry, barberry, currant, elderberry, gooseberry, hackberry, mayapple, Oregon grape, wolfberry, mulberry, arhat, che, k-pong, persimmon, sageretia, cocoplum, pawpaw, Saw Palmetto, Toyon, dragonfruit, prickly pear, Saguaro, date, fig, olive, pomelo, citron, lemon, limes, avocado, tamarillo, banana, bael, babco, akee, guarana, or others. One of skill in the art would recognize that any variety or hybrid of fruit or vegetable, including any variety of apples, pears, Asian pears, cherries, or any other fruit could be used to practice the presently claimed invention.

In particular, varieties of apples that may be used for certain embodiments include, but are not limited to: Red Delicious, Golden Delicious, Gala, Fuji, Rome, Ginger Gold, Granny Smith, Braeburn, Cameo, Pink Lady, Jonagold, Rome Beauty, Wealthy, Stayman, Jonathan, McIntosh, Cortland, Akane, Jonamac, Nittany, Vista Bella, Elstar, Royal Gala, Winter Banana, or any combination of these or any other varieties. Particular varieties of pears that may be used in certain embodiments include, but are not limited to: European or Asian pears, Bartlett, Red Bartlett, Taylor's Gold™, Concorde™, Seckel, Red Anjou, Green Anjou, Bosc, Comice, Forelle, D'Anjou, Clairgeau, Easter Beurre, Flemish Beauty, Kieffer, Pound, Sheldon, Winter Nelis, P. Barry, or any combination of these or any other varieties. Particular varieties of cherries that may be used in certain embodiments include, but are not limited to: Bing, Black Tartarian, Brook, Tulare, Garnet, Chelan, Lapin, Sonata, Hill Bing, Hill Lambert, Hill Lapin, Sweetheart, Skeena, Staccato, Schmidt, Chapman, Republican, Lambert, Ranier, Regina, Sandra Rose, Van, Sonata, Black Gold, Early Robin, Attika, and any combination thereof.

One of skill in the art would recognize that the present invention may be practiced with fruit or vegetables that are cultivated, organic, genetically modified, hybrid cross, or wild cultivars.

Fruit and Vegetable Grades

Certain embodiments relate to methods for assessing fruit or vegetable quality based on one or more fruit or vegetable grade assessments selected from the group consisting of measuring sugar content or testing soluble solids; measuring whole fruit or vegetable size; measuring starch content; measuring firmness or pressure; testing acidity; assessing color; assessing seed color; assessing taste or general “mouth feel”; assessing texture and assessing aroma.

One particular exemplary embodiment disclosed herein includes that the fruit or vegetable comprises an apple. In one exemplary embodiment wherein the fruit comprises an apple, the fruit may have a United States Department of Agriculture federal grade selected from the group consisting of: U.S. No. 1, U.S. Fancy, U.S. Extra Fancy and any combination thereof. In certain embodiments wherein the fruit comprises an apple, the fruit product comprises applesauce. In certain embodiments wherein the fruit product comprises applesauce, the applesauce may be of any United States Department of Agriculture federal grade, including U.S. Grade A or U.S. Grade B.

Alternatively, the fruit or vegetables used for certain embodiments herein may have any federal grade available, including any grade level utilized internationally.

Accordingly, this disclosure includes the U.S. Standards for Grades of Apples, §§51.300-51.321 of the Agricultural Marketing Act, as amended (7 U.S.C. 1624), are hereby incorporated by reference in its entirety. Several specific standards for apple grades are disclosed herein, as well as in Tables 1 and 2.

As used herein, the federal food grade of fruit refers to the criteria established by the U.S. Department of Agriculture. In particular, “U.S. Extra Fancy” includes apples of one variety (except where more than one variety is printed on the container) which are mature but not overripe, clean, fairly well formed and relatively free from decay, internal browning, internal breakdown, soft scald, scab, freezing injury, visible water core, and broken skins. “U.S. Extra Fancy” apples are also relatively free from injury caused by bruises, brown surface discoloration, smooth net-like russeting, sunburn or sprayburn, limb rubs, hail, drought spots, scars, disease, insects, or other means. “U.S. Extra Fancy” apples are relatively free from damage caused by bitter pit or Jonathan spot and by smooth solid, slightly rough or rough russeting, or stem or calyx cracks, as well as damage by invisible water core after January 31^{st} of the year following the year of production except for Fuji variety of apples.

As used herein, “U.S. Fancy” apples include apples of one variety (except when more than one variety is printed on the container) which are relatively mature but not overripe, clean, fairly well formed, and relatively free from decay, internal browning, internal breakdown, soft scald, freezing injury, visible water core, and broken skins. “U.S. Fancy” apples are also relatively free from damage caused by bruises, brown surface discoloration, russeting, sunburn or sprayburn, limb rubs, hail, drought spots, scars, stem or calyx cracks, disease, insects, bitter pit, Jonathan spot, or damage by other means, or invisible water core after January 31^{st} of the year following the year of production, except for Fuji variety of apples.

As used herein, “U.S. No. 1” includes apples which meet the requirements of “U.S. Fancy” grade except for certain characteristics, such as color, russeting, and invisible water core. “U.S. No. 1” apples are relatively free from excessive damage caused by russeting. That is, the apples meet the russeting requirements for “U.S. Fancy,” except the aggregate area of an apple which may be covered by smooth net-like russeting usually does not exceed 25%; and the aggregate area of an apple which may be covered by smooth solid russeting usually does not exceed 10%, except that in the case of the Yellow Newtown or similar varieties, the aggregate area of an apple which may be covered with smooth solid russeting usually does not exceed 20%. Invisible water core is generally not scored in this grade.

As used herein, “U.S. No. 1 Hail” includes apples that meet the requirements of U.S. No. 1 grade except that hail marks where the skin has not been broken and well-healed hail marks where the skin has been broken, are permitted, provided the apples are fairly well formed.

As used herein, “U.S. Utility” includes apples of one variety (except when more than one variety is printed on the container) that are relatively mature but not overripe, not seriously deformed and relatively free from decay, internal browning, internal breakdown, soft scald, and freezing injury. “U.S. Utility” apples are also relatively free from serious damage caused by dirt or other foreign matter, broken skins, bruises, brown surface discoloration, russeting, sunburn or sprayburn, limb rubs, hail, drought spots, scars, stem or calyx cracks, visible water core, bitter pit or Jonathan spot, disease, insects or other means.

In addition to these typical characteristics, apple varieties of the grades disclosed herein also typically have the color specified in Table 1. Apple varieties other than those listed in Table I have no color requirements pertaining to these grades.

TABLE 1

| The apple | | | |
|---|---|---|---|
| varieties listed | | | |
| below have color | | | |
| requirements | U.S. Extra Fancy | U.S. Fancy | U.S. No. 1 |
| VARIETY | PERCENT | PERCENT | PERCENT |
| Red Delicious | 66 | 40 | 25 |
| Red Rome | 66 | 40 | 25 |
| Empire | 66 | 40 | 25 |
| Idared | 66 | 40 | 25 |
| Winesap | 66 | 40 | 25 |
| Jonathan | 66 | 40 | 25 |
| Stayman | 50 | 33 | 25 |
| McIntosh | 50 | 33 | 25 |
| Cortland | 50 | 33 | 25 |
| Rome Beauty | 50 | 33 | 25 |
| Delicious | 50 | 33 | 25 |
| York | 50 | 33 | 25 |

As used in Table 1, the color requirements for the solid red varieties indicate the percentage of the area of the surface, which should be covered with a good shade of solid red characteristic of the variety. However, an apple having color of a lighter shade of solid red or striped red than that considered as a good shade of red characteristic of the variety may be admitted to a grade, if it has sufficient additional area covered so that the apple has as good an appearance as one with the minimum percentage of good red characteristic of the variety required for the grade. For the striped red varieties, the percentage stated refers to the area of the surface in which the stripes of a good shade of red characteristic of the variety typically predominates over stripes of lighter red, green or yellow. However, an apple having color of a lighter shade than that considered as a good shade of red characteristic of the variety may be admitted to a grade, provided it has sufficient additional area covered so that the apple has as good appearance as one with the minimum percentage of stripes of a good red characteristic of the variety required for the grade.

Color standards U.S. Dept. of Agriculture Visual Aid APL-CC-1 (Plates a-e), hereby incorporated by reference in their entireties, illustrate minimum good shade of solid red or striped red color, minimum compensating color and shade not considered color, for the following varieties: Red Delicious, Red Rome, Empire, Idared, Winesap, Jonathan, Stayman, McIntosh, Cortland, Rome Beauty, Delicious and York.

When size is designated by the numerical count for a container, typically not more than 10% of packages in the lot may fail to be fairly uniform. As used herein, “fairly uniform” may indicate that the size of the fruit within the container does not vary more than ½ inch diameter from the smallest to largest fruit, and that any particular apple may be slightly abnormal in shape but not to an extent which detracts materially from its appearance.

When size is designated by minimum or maximum diameter, generally not more than a5% of the apples in any lot may be smaller than the designated minimum, and generally not more than 10% may be larger than the designated maximum. For Red Delicious or Golden Delicious varieties, a combination of minimum diameter and/or weight may be used.

Any decay, scald, or other deterioration which may have developed on apples after they have been in storage or transit is generally considered as affecting the condition of the apples, and not the grade.

Generally, as used in the U.S.D.A. guidelines and herein, “mature,” refers to apples that have reached the stage of development which will insure the proper completion of the ripening process. Before a mature apple becomes overripe, it will show varying degrees of firmness, depending on the stage of the ripening process.

In addition to the term, “mature,” apples may be referred to by the following U.S.D.A. descriptions: “hard,” generally refers to apples with a tenacious flesh and starchy flavor; “firm,” generally refers to apples with a tenacious flesh but which are becoming crisp with a slightly starchy flavor, except the Delicious variety; “firm ripe,” generally refers to apples with crisp flesh except that the flesh of the Gano, Bed Davis, and Rome Beauty varieties may be slightly mealy; “ripe,” generally refers to apples with mealy flesh and soon to become soft for the variety; and “overripe,” generally refers to apples which have progressed beyond the stage of ripe, with flesh very mealy or soft, and past commercial utility.

In addition to these U.S.D.A. standard grades for fresh apples, the present disclosure also includes the U.S.D.A. standards for grades of frozen apples (§§52.361-52.371 of the Agricultural Marketing Act, as amended), dried apples (§§52.2481-52.2490 of the Agricultural Marketing Act, as amended), dehydrated (low moisture) apples (§§52.2341-52.2352 of the Agricultural Marketing Act, as amended) and canned apples (§§52.2161-52.2173 of the Agricultural Marketing Act, as amended), all of which are hereby incorporated by reference in their entireties.

In any of the particular embodiments set forth herein, the fruit used to practice the presently claimed invention has a Washington state grade selected from the group consisting of: Washington Extra Fancy, Washington Fancy, Washington C grade and any combination thereof. Alternatively, the fruit used to practice the presently claimed invention has any state grade available. As used herein, the Washington state apple grades specified refer to the standard grades set forth by the Washington State Department of Agriculture, Chapter 16-403 WAC, which is hereby incorporated by reference in its entirety. Except where noted, the Washington State apple term definitions parallel the U.S.D.A. definitions, and such definitions may be used interchangeably herein.

As used herein, “Washington Extra Fancy” apples include apples of one variety which are relatively mature but not overripe, carefully hand picked, clean, fairly well formed, relatively free from decay, internal browning, internal breakdown, scald, scab, bitter pit, Jonathan spot, freezing injury, visible watercore, and broken skins and bruises except those which are slight and incident to proper handling and packing. “Washington Extra Fancy” apples are also relatively free from injury caused by smooth net-like russeting, sunburn or spray-burn, limb rubs, hail, drought spots, scars, disease, insects or other means; and relatively free from damage by smooth solid, slightly rough or rough russeting, or stem or calyx cracks and free from damage by invisible watercore after January 31^{st} of the year following the year of production, provided that the invisible watercore is not be a quality factor of Fuji variety at any time.

As used herein, “Washington Fancy” apples refer to apples of one variety which are mature but not overripe, carefully hand-picked, clean, fairly well-formed; relatively free from decay, internal browning, internal breakdown, bitter pit, Jonathan spot, scald, freezing injury, visible watercore, and broken skins and bruises, except those which are incident to proper handling and packing. “Washington Fancy” apples are also relatively free from damage caused by russeting, sunburn or sprayburn, limb rubs, hail, drought spots, scars, stem or calyx cracks, disease, insects, invisible watercore after January 31^{st of} the year following the year of production, or damage by other means, provided that invisible watercore is not a quality factor of Fuji variety at any time.

As used herein, “Washington C grade” includes the same requirements for “Washington Fancy” except for color, russeting and invisible watercore. “Washington C grade” apples are relatively free from excessive damage caused by russeting with the aggregate area of an apple covered by smooth net-like russeting typically will not exceed 25%, except that with the Yellow Newtown, Granny Smith or similar varieties, the aggregate area of an apple which may be covered with smooth solid russeting typically will not exceed 20%; and the aggregate area of an apple which may be covered with excessively rough or barklike russeting or limb rubs will generally not exceed the area of a circle three-fourths of an inch in diameter.

Color requirements for all Washington State grades listed are described in Tables 2 and 3. For the solid red varieties listed in Table 2, the percentage stated refers to the area of the surface which must be covered with a good shade of solid red characteristic of the variety. However, an apple having color of a lighter shade of solid red or striped red than that considered as a good shade of red characteristic of the variety may be admitted to a grade provided it has sufficient additional area covered so that the apple has as good an appearance as one with the minimum percentage of good red characteristic of the variety required for the grade.

TABLE 2

| | EXTRA FANCY | FANCY |
|---|---|---|
| SOLID RED VARIETY | PERCENT | PERCENT |
| Black Ben | 50-66 | 33-40 |
| Gano | 50-66 | 33-40 |
| Winesap | 50-66 | 33-40 |
| Other similar varieties | 50-66 | 33-40 |
| Red sport varieties | 66 | 33-40 |

For the striped or partial red varieties listed in Table 3, the percentage stated refers to the area of the surface in which the stripes of a good shade of red characteristic of the variety typically predominates over stripes of lighter red, green or yellow. However, an apple having a color of a lighter shade than that considered as a good shade of red characteristic of the variety may be admitted to a grade, provided it has sufficient additional area covered so that the apple has as good an appearance as one with the minimum percentage of stripes of a good red characteristic of the variety required for the grade. Faded brown stripes are generally not considered as color.

TABLE 3

| | EXTRA FANCY | FANCY |
|---|---|---|
| VARIETY | PERCENT | PERCENT |
| Delicious | 50 | 25 |
| Rome Beauty | 35-50 | 15-33 |
| Wealthy | 50 | 25 |
| Stayman | 50 | 33 |
| Other similar varieties | 50 | 25 |
| Jonathan | 35-66 | 15-33 |
| McIntosh | 35-50 | 15-33 |
| Cortland | 50 | 33 |
| Akane | 33⅓ | 15 |
| Jonamac | 50 | 33 |
| Nittany | 25 | 10 |
| Vista Bella | 25 | 10 |
| Other similar varieties | 50 | 33 |
| Red sport varieties | 66 | 33-40 |

For the red cheeked or blushed varieties, such as Braeburn, Elstar, Fuji, Gala and Royal Gala, Jonagold, Winter Banana and other similar varieties, “Washington Extra Fancy” apples require a blush cheek, while “Washington Fancy” apples require a tinge of color. For the green or yellow varieties, such as Golden Delicious, for “Washington Extra Fancy” or “Washington Fancy,” grades, 75% or more of the surface of the apple typically will show white or light green predominating over the green color. In “Washington C grade,” 33⅓% or more of the surface of the apple will typically show white or light green predominating over the green color.

In addition to these state guidelines, WAC Chapter 16 includes the state guideline standards for other various fruits that are included in the present disclosure, and is hereby incorporated by reference in its entirety.

In addition to the U.S. federal and Washington state guidelines, the present disclosure also includes international guidelines for fruit standard grades. For example, The European Community Marketing Standards for Fresh Fruits and Vegetables, European Council Regulation No. 2200/1996, Council Regulation No. 444/2004, Amending Regulation No.1535/2003 laying down detailed rules for applying Council Regulation No. 2201/96 as regards the aid scheme for products processed from fruits and vegetables, and Council Regulation No.1010/2001, all of which are hereby incorporated by reference in their entireties, as set forth regulations and marketing standards for fresh fruits and vegetables.

Briefly, the EC marketing standards state fresh fruit must be sound, clean and of marketable quality, and that each container or display of produce must be clearly marked with the correct information regarding quality class, origin and—in some cases—variety. For example, apples, apricots, avocados, cherries, citrus fruit, kiwifruit, melons, nectarines, peaches, plums, strawberries, table grapes and watermelons may be classified as part of three main quality classes: Extra Class, Class I and Class II. As used herein, “Extra Class” includes produce of excellent quality and specially selected produce; “Class I” may refer to good quality produce, well-shaped and colored and generally free of blemishes and marks, while “Class II” produce refers to produce of sound marketable quality with certain allowances in relation to shape, coloring and slight minor defects such as blemishes, healed cracks or marks.

In addition other international standards or grades may be used, including the Canadian Agricultural Products Act Fresh Fruit and Vegetable Regulations, (C-0.4/C.R.C.-c.285, Schedule I, §§1-56, as amended Aug. 31, 2004),as well as the Canadian Processed Products Regulations and Maple Products Regulations (C.R.C., c. 291), which are hereby incorporated by reference in their entireties.

For example, fresh apples graded in Canada include “Canada Extra Fancy,” “Canada Fancy,” “Canada Commercial,” “Canada Hailed,” “Canada Commercial Cookers,” “Canada No. 1 Peelers” and “Canada No. 2 Peelers.”

As used herein, “Canada Extra Fancy” apples may include apples that are smooth and well formed, are relatively free form bruises; be relatively free from hail damage that has broken the skin or has caused discoloration, be relatively free from limb rub that is depressed, be relatively free from russeting, be relatively free from scab, including pinpoint scab, be relatively free from insect damage, be relatively free from insects and disease, be relatively free from Jonathan spot, drought spot or marks resembling drought spot, be relatively free from sprayburn or sunscald and be relatively free from skin breaks at the stem.

As used herein, “Canada Fancy,” apple grade refers to apples that are relatively smooth and fairly well-formed, relatively free from bruises, relatively free from hail damage, relatively free from limb rub, relatively free from russeting, relative free from pinpoint scab, relatively free from storage scald, relatively free from sprayburn and sunscald, relatively free from insect damage, relatively free from insects, relatively free from Johathan spot, drought spot or marks resembling drought spot and be relatively free from skin breaks at the stem.

As used herein, “Canada Commercial” apple grade refers to apples that are relatively free from bruises, relatively free from hail damage, relatively free from limb rub, relatively free from russeting, relatively free from scab, relatively free from storage scald, relatively free from sprayburn and sunscald, relatively free from drought spot or marks resembling drought spot and relatively free from insect damage.

As used herein, “Canada Hailed” apple grade includes apples that are relatively free from hail damage, and have not less than the amount of color required for “Canada Fancy.”

As used herein, “Canada Commercial Cookers” include apples that meet the standards of the Canada Commercial grade, with the exceptions of russeting and scab, be mature except for Northern Spy varieties, and have a minimum diameter of 63 mm (2½ inches) except for Northern Spy varieties.

As used herein, “Canada No. 1 Peelers” grade refers to apples that are one variety and fairly well formed, are fairly clean, mature and sound; have a minimum diameter of 57 mm (2¼ inches), be relatively free from insect larvae, and be free from any damage or defect.

As used herein, “Canada No. 2 Peelers” include apples that are generally of one variety, are reasonably clean, mature and sound, have a minimum diameter of 57 mm (2¼ inches); be relatively free from insect larvae and be relatively free from any damage or defect.

The color requirement for the Canadian apple standards are set forth in Table 4. In the case of solid red or fully striped varieties, or partially red or partially striped varieties, the apple must be of a red or red striped color on a proportion of their surface area that is at least equal to the percentage set out in Table 4. In the case of red cheeked, blush, green, yellow or russet varieties, the apple must have the minimum shade of color described Table 4.

TABLE 4

| | CANADA | | |
|---|---|---|---|
| COLOR | EXTRA | CANADA | CANADA |
| CATEGORY | FANCY | FANCY | COMMERCIAL |
| Solid red or fully | 65% | 40% | 15% |
| striped varieties | | | |
| Partially red or | 55% | 30% | 15% |
| partially striped | | | |
| varieties | | | |
| Red cheeked or | Perceptibly blush- | Tinge of color | — |
| blush varieties | cheeked | | |
| Green, yellow or | Color | Color | — |
| russet varieties | characteristic of | characteristic | |
| | variety when | of variety when | |
| | mature | mature | |

For processed fruits and vegetables, the Canadian grades include, “Canada Fancy,” or “Canada A;” “Canada Choice,” or “Canada B;” and “Canada Standard,” or “Canada C.” These grades apply to imported as well as domestic produce.

In addition to the guidelines set forth herein, the present disclosure further relates to other various fruit, the standards for which are included in the U.S. Agricultural Marketing Act of 1946 (as amended), which is hereby incorporated by reference in its entirety, and WAC Chapter 16 of the Washington state guidelines, which is also hereby incorporated by reference in its entirety.

In certain embodiments of the invention, the fruit suitable for flavoring includes cherries. The present disclosure includes the U.S.D.A. guidelines for cherries, such as §§51.4340-51.4348 (for red sour cherries) and §§51.2646-51.2660 (for sweet cherries) of the Agricultural Marketing Act, as amended, which are hereby incorporated by reference in their entireties. The present disclosure further includes the Washington State Department of Agriculture standards for cherries, as wet forth in WAC Chapter 16, which is hereby incorporated by reference in its entirety. The present disclosure further includes the European and Canadian standards for cherries, described in the documents cited herein which were previously incorporated by reference.

For example, cherries used in any embodiments of the present disclosure may include the grade of “U.S. No. 1,” or “U.S. Commercial” grade according to the U.S.D.A. federal regulations, “Washington No. 1” or “Northwest No. 1,” according to the Washington state guidelines, or another grade.

In another example, peaches used in any embodiments of the present disclosure may include the grade of “U.S. Grade A” or “U.S. Fancy;” “U.S. Grade B” or “U.S. Choice;” “U.S. Grade C” or “U.S. Standard;” “U.S. Grade D” or “U.S. Substandard;” “U.S. No. 1;” “U.S. No. 2;” “Washington Extra Fancy,” “Washington Fancy,” or another grade.

As recognized under the U.S. Standards for Grades of Canned Applesauce (47 FR 5877) and its amendments, color, flavor, types of pack, styles and all other terms and definitions (for example from §52.331-§52.345) are hereby incorporated by reference and used similarly herein unless otherwise noted. For example, certain embodiments disclosed herein may include regular or comminuted applesauce has been reduced to granular particles, or chunky applesauce that has been chopped into small pieces. In this regard, applesauce that is “U.S. Grade A” meets the quality requirements of Table 5 or Table 6 and scores not less than 90 points. By contrast, applesauce that is graded “U.S. Grade B” meets the quality requirements of Table 5 or Table 6 and scores not less than 80 points. Substandard quality fails to meet the requirements of U.S. Grade B.

TABLE 5
Regular or Comminuted

| Factors | Grade A | Grade B |
|---|---|---|
| Color: | | |
| Natural: | Bright, practically uniform, | Dull, reasonably uniform, |
| | typical of variety or | typical of variety or |
| | varieties used, no | varieties used. Slightly |
| | discoloration due to | brown, slightly pink, or |
| | oxidation or scorching. | slightly grey. |
| Spice flavored: | Characteristic of the color | The color imparted by |
| | imparted by added spice, | added spice may be |
| | free from discoloration | slightly affected by pink or |
| | due to oxidation or | grey color, but is not off |
| | scorching. | color. |
| Artificially colored | Bright and distinct. | Reasonably bright and |
| | | distinct. |
| SCORE POINTS | 18-20 | 16-17 |
| Consistency: | | |
| Product Flow: | Not more than 6.5 cm (2.5 in) | Not more than 8.5 cm (3.3 in) |
| Free liquid: | Not more than 0.7 cm (0.3 in) | Not more than 1 cm (0.4 in) |
| SCORE POINTS | 18-20 | 16-17 |
| Absence of Defects: | | |
| Dark stamens: | Not more than 3 | Not more than 5 |
| Seed particles, discolored | Not more than 0.5 cm² | Not more than 1.0 cm² |
| apple particles, carpel | (0.08 in²) Total but, | (0.16 in²) Total but |
| tissue: | Not more than 0.25 cm² | Not more than 0.5 cm² |
| Medium and dark colored | (0.04 in²) | (0.08 in²) |
| particles | | |
| SCORE POINTS | 18-20 | 16-17 |
| Finish | | |
| | Evenly divided, not lumpy, | Evenly divided, slightly |
| | pasty or salvy. | slavy or pasty. |
| SCORE POINTS | 18-20 | 16-17 |
| Flavor: | | |
| | Good natural sugar-acid | Reasonably good natural |
| | balance. | sugar-acid balance. |
| Unsweetened: | Slightly tart or slightly | Moderately tart, may be |
| | bland. Free from | bland, slightly astringent |
| | astringent flavor. | flavor. |
| Sweetened: | Slightly tart to sweet. | May be tart, not |
| | Free from astringent | excessively sweet, slightly |
| | flavor. | astringent. |
| Spice flavored: | Flavor is distinct and | Flavor derived from |
| | characteristic of the | added flavoring(s) or |
| | added spice(s) or | spice(s) may be slightly |
| | flavoring(s) but not strong. | weak or strong but not |
| | | objectionable. |
| SCORE POINTS | 18-20 | 16-17 |
| Total Score: | 90-100 | 80-89 |
| Analytical: | | |
| Brix-unsweetened | Not less than 9.0 degrees | Not less than 9.0 degrees |
| Brix-sweetened | Not less than 15.5 | Not less than 14.5 |
| | degrees | degrees |

TABLE 6
Chunk or Chunky

| Factors | Grade A | Grade B |
|---|---|---|
| Color: | | |
| Natural: | Bright, practically uniform, | Dull, reasonably uniform, |
| | typical of variety or | typical of variety or |
| | varieties used, no | varieties used. Slightly |
| | discoloration due to | brown, slightly pink, or |
| | oxidation or scorching. | slightly grey. |
| Spice flavored: | Characteristic of the color | The color imparted by |
| | imparted by added spice, | added spice may be |
| | free from discoloration | slightly affected by pink or |
| | due to oxidation or | grey color, but is not off |
| | scorching. | color. |
| Artificially colored | Bright and distinct. | Reasonably bright and |
| | | distinct. |
| SCORE POINTS | 18-20 | 16-17 |
| Consistency: | | |
| Product Flow: | Not more than 7.5 cm | Not more than 9.5 cm |
| | (2.95 in) | (3.75 in) |
| Free liquid: | Slight amount. | Moderate amount. |
| SCORE POINTS | 18-20 | 16-17 |
| Absence of Defects: | | |
| Dark stamens: | Not more than 3 | Not more than 5 |
| Seed particles, discolored | Not more than 0.5 cm² | Not more than 1.0 cm² |
| apple particles, carpel | (0.08 in²) Total but, | (0.16 in²) Total but |
| tissue: | Not more than 0.25 cm² | Not more than 0.5 cm² |
| Medium and dark colored | (0.04 in²) | (0.08 in²) |
| particles | | |
| SCORE POINTS | 18-20 | 16-17 |
| Finish | | |
| | High proportion of apple | Fairly high proportion of |
| | chunks. Any fine apple | apple chunks. Any fine |
| | particles present, do no | apple particles present, |
| | more than moderately | do not seriously affect eh |
| | affect the appearance of | appearance or eating |
| | eating quality of the | quality of the product. |
| | product. | |
| SCORE POINTS | 18-20 | 16-17 |
| Flavor: | | |
| | Good natural sugar-acid | Reasonably good natural |
| | balance. | sugar-acid balance. |
| Unsweetened: | Slightly tart or slightly | Moderately tart, may be |
| | bland. Free from | bland, slightly astringent |
| | astringent flavor. | flavor. |
| Sweetened: | Slightly tart to sweet. | May be tart, not |
| | Free from astringent | excessively sweet, slightly |
| | flavor. | astringent. |
| Spice flavored: | Flavor is distinct and | Flavor derived from |
| | characteristic of the | added flavoring(s) or |
| | added spice(s) or | spice(s) may be slightly |
| | flavoring(s) but not strong. | weak or strong but not |
| | | objectionable. |
| SCORE POINTS | 18-20 | 16-17 |
| Total Score: | 90-100 | 80-89 |
| Analytical: | | |
| Brix-unsweetened | Not less than 9.0 degrees | Not less than 9.0 degrees |
| Brix-sweetened | Not less than 15.5 | Not less than 14.5 |
| | degrees | degrees |

In certain embodiments, the applesauce soluble solids may fall within the range of 18.0° to 24.0° brix, or greater or less than. In certain embodiments, the pH of the applesauce may fall within the range of 3.0-4.2 or greater or less than. In certain embodiments, the acidity of the applesauce may fall within 0.25-0.50 grams/100 grams or greater or less than.

The fruit or vegetable produce guidelines disclosed herein further encompass the produce sheets of Choice Plus, Publication No. FCS-297, a joint publication of the U.S.D.A. and the National Food Service Management Institute at the University of Mississippi. (See the website at pma.com). In addition to these guidelines, the present invention may include fruits and vegetables that fall under any number of other federal, state or local guidelines. Such guidelines may include those established under NAFTA, the United Nations, other treaties or other laws.

Fruit Characteristics

One of skill in the art would realize that the fruit(s) and/or vegetable(s) suitable for disclosed embodiments may be assessed in a variety of ways. In particular, tests of soluble solids, acidity, size or weight, starch content, firmness, or other factors may determine the suitability of the produce.

### Apples

In one embodiment, apples suitable for processing will have soluble solids measurement of fruit sugar content of 9 brix or higher. In one particular embodiment, the test of soluble solids measurement of fruit sugar content is 12 brix or higher. In another particular embodiment, the test of soluble solids measurement of fruit sugar content is 13 brix or higher. In yet another embodiment, the test of soluble solids measurement of fruit sugar content is 14 brix or higher.

In one embodiment, apples suitable for processing may be assessed by size or weight. One of skill in the art will recognize that whole fruit or vegetable size may be measured in a number of ways. In particular, the diameter of whole fruit or vegetable size may be measured, carton “count” may be measured, or its packaged weight may be measured. An exemplary embodiment of the present invention includes apples that measure from 2 to 4 inches in diameter. If the whole fruit size is measured as a “count” of fruit per standard 40 or 48 lb. Carton, or its metric equivalent, fruit size for one example embodiment of the invention is from 72 count to 163 count. In another particular embodiment, the measurement of whole fruit size is 100 count or less. In another particular embodiment, the measurement of whole fruit size is 150-48 lb, or its metric equivalent.

One of skill in the art will also recognize that measuring fruit acidity may, alone or in combination with other factors, indicate the quality of the fruit suitable for processing. In an exemplary embodiment of the present invention, wherein the fruit is an apple, the fruit acidity is in the range of pH 1.5-6.0. In another particular embodiment, the fruit acidity is in the range of pH 4.0-7.0.

One of skill in the art will further recognize measuring starch content may, alone or in combination with other factors, indicate the quality of the fruit suitable for processing. In an example embodiment, wherein the fruit is an apple, the fruit starch content is in the range of 1.0-6.0. In another embodiment, the fruit starch content is in the range of 2.5-3.0.

As one of skill in the art would recognize, measuring fruit firmness, alone or in combination with other factors, may indicate quality of the fruit suitable for processing. In an exemplary embodiment, wherein the fruit is an apple, the fruit firmness is in the range of 10 force pounds (lbf) or higher. In another embodiment, the fruit firmness is in the range of 11 force pounds (lbf) or higher. In another embodiment, the fruit firmness is in the range of 10-17 force pounds (lbf).

Pears

In another particular embodiment, pears may be used. The present disclosure includes standards for grades of pears as described by the U.S. Department of Agriculture (§§51. 1345-51.1359 of the Agricultural Marketing Act as amended, and §§51.1300-51.1323 of the Agricultural Marketing Act, as amended), which are hereby incorporated by reference in their entireties.

In general, and as used herein, “U.S. Extra No. 1” pears include fruit of one variety which are mature, but not overripe, carefully hand-picked, clean, well formed, relatively free from decay, internal breakdown, scald, freezing injury, worm holes, black end, hard end, drought spot, and relatively free from injury caused by russeting, limb rubs, hail, scars, cork spot, sunburn, sprayburn, stings or other insect injury, or mechanical or other means, except that they shall be relatively free from damage caused by bruises, broken skins, or disease.

In general, and as used herein, “U.S. No. 1” for fresh pears includes pears of one variety which are relatively mature, but not overripe, carefully hand-picked, clean, fairly well formed, relatively free from decay, internal breakdown, scald, freezing injury, worm holes, black end, and from damage caused by hard end or broken skins. The “U.S. No. 1” fresh pears are also generally free from serious damage caused by bruises, russeting, limb rubs, hail, scars, cork spot, drought spot, sunburn, sprayburn, stings or other insect injury, disease, or mechanical or other means.

In general, and as used herein, “U.S. No. 1” for processing pears includes pears of one variety which are relatively mature, handpicked, firm, well formed, free from scald, hard end, black end, internal breakdown, decay, worms and worm holes, and from damage caused by broken skins, limb rubs, sprayburn, sunburn, scab, russeting, bruises, hail, frost, drought spot, disease, insects, mechanical or other means. Unless otherwise specified, the “U.S. No. 1” pears for processing are generally not further advanced than yellowish green. In general, tree-ripened pears and pears grown from late blooms are not considered as meeting the requirements of this grade.

In general, and as used herein, “U.S. No. 2” for processing pears includes pears of one variety which are relatively mature, hand-picked, firm, not seriously deformed, free from scald, hard end, black end, internal breakdown, decay, worms and worm holes, and free from serious damage by any other cause. Unless otherwise specified, the pears in this grade are not further advanced than yellowish green. In general, tree-ripened pears and pears grown from late blooms shall not be considered as meeting the requirements of this grade.

In general, and as used herein, “Unclassified” includes pears which have not been classified in accordance with any of the foregoing grades. As such, “Unclassified” is not a grade within the meaning of the U.S.D.A. standards, but is provided to designate that no grade has been applied to the lot. In addition, “culls” are pears which do not meet the requirements of any of the foregoing grades for fresh or processing pears.

As used herein, “serious damage” may refer to any injury or defect which seriously affects the appearance, or the edible or shipping quality. In addition, for processing pears, “serious damage” cannot be removed during the usual commercial preparation for use without a loss of over 20%, by weight, of the pear in excess of that which would occur if the pear were not defective.

As with any fruit, decay, scald or other deterioration which may have developed on pears after they have been in storage or transit are generally considered as affecting fruit condition and not the grade thereof.

As used herein to describe pears, “mature” generally refers to pears that have reached the stage of maturity which will insure the proper completion of the ripening process, and before the fruit has become overripe it will show varying degrees of firmness depending on the stage of the ripening process. Thus, a description of firmness may also be given in order to indicate the stage of the ripening process.

In referring to the firmness of pears, “hard” means the flesh of the pear is solid and does not yield appreciably even to considerable pressure; “firm” means that the flesh of the pear is fairly solid but yields somewhat to moderate pressure but is not wilted, shriveled, rubbery or flabby; “firm ripe” means that the flesh of the pear yields readily to moderate pressure; “ripe” means that the pear is at the stage where it is in its most desirable condition for eating; “overripe” means dead ripe, very mealy or soft, past commercial utility. Generally, a description of the ground color may also be given, according to “green,” “light green,” “yellowish green,” and “yellow.”

As used herein, “hand-picked” may refer to fruit that does not show evidence of having been on the ground, and “carefully hand-picked” may refer to fruit that shows no evidence of rough handling or of having been on the ground. As used herein, “black end” is indicated by an abnormally deep green color around the calyx, or black spots usually occurring on the one-third of the surface nearest to the calyx, or by an abnormally shallow calyx cavity.

One of skill in the art would recognize that the test of soluble solids measurement of fruit sugar content in raw pears may be immeasurably low due to incomplete ripening. By contrast, the test of soluble solids measurement may be greater or less than 5 Brix, 7 Brix, 9 Brix, 11 Brix, 12 Brix, 13 Brix, or any value therebetween.

Pear size may be measured as individual fruit size or whole packaged size or weight. In particular, the measurement of individual fruit size may be from 2 to 4 inches in diameter. Alternatively, the whole fruit size as measured by a “count” of fruit per standard 40 or 48 lb. carton, or its metric equivalent, may be from 72 count to 163 count. In one particular embodiment, the measurement of whole fruit size is 100 count or less. In another particular embodiment, the measurement of whole fruit size is 150-48 lb, or its metric equivalent.

One of skill in the art would recognize that fruit acidity, alone or in combination with other factors, may indicate fruit quality in fruit suitable for processing. In a particular embodiment, the fruit acidity of the pear used is in the range of pH 1.5-6.0. In another particular embodiment, the fruit acidity of the pear is in the range of pH 4.0-7.0.

One of skill in the art would recognize other factors in determining fruit quality are fruit starch and/or fruit firmness in fruit suitable for processing. In particular, the fruit starch content of a pear used in the present invention is in the range of 1.0-6.0. In any particular embodiment, the firmness of the pear is in the range of 8 force pounds (lbf) or higher.

In the particular embodiment wherein the fruit is a pear, the fruit has a United States Department of Agriculture federal grade selected from the group consisting of: U.S. Extra No. 1, U.S. No. 1, and any combination thereof. Alternatively, the fruit or vegetables used in any particular embodiment may have any state or federal grade available.

In another particular embodiment, the present invention relates to Asian pears. One of skill in the art would recognize that Asian pears include “Tsu Li,” “Ya Li,” Kikusui,” “Nijisseiki,” “20^{th} Century,” “Seigyoku,” “Shinseiki,” “Chojuro,” “Doitsu,” “Imamura Aki,” “Hosui,” “Kosui,” Niitaka,” “Shinko,” “Ishiiwase,” and other Chinese or Japanese varieties or cultivars. Other common names for Asian pears include Oriental pears, Chinese pears, Japanese pears, nashi, sand apples, salad pears, “apple pears,” and others.

In certain aspects, Asian pears that are suitable for processing have a firmness of approximately 7-25 lbs. In certain aspects, the Asian pears have a firmness of approximately 7 lbs, 8 lbs, 9 lbs, 10 lbs, 11 lbs, 12 lbs, 13 lbs, 14 lbs, 15 lbs, 16 lbs, 17 lbs, 18 lbs, 19 lbs, 20 lbs, 21 lbs, 22 lbs, 23 lbs, 24 lbs, 25 lbs, or any value therebetween.

In certain aspects, the Asian pears that are suitable for processing may have approximately 11-14% soluble solids. In certain aspects, the Asian pears that are suitable for processing may have approximately 11.0%, 11.5%, 12.0%, 12.5%, 13.0%, 13.5%,14.0%, 14.5% soluble solids or any value therebetween or greater.

One of skill in the art would recognize a variety of other factors may be considered in determining the quality control of Asian pears suitable for processing.

### Cherries

Another particular embodiment relates to cherries. In certain aspects of this embodiment, the fruit sugar content of cherries suitable for processing is approximately 10-27%. In certain aspects of this embodiment, the fruit sugar content of cherries suitable for processing is approximately 10%, 11%, 12%, 13%, 14%,15%,16%,17%,18%,19%, 20% 21%, 22%, 23%, 24%, 25%, 26%, 27%, or any value therebetween. As one of skill in the art would understand, total soluble solids content may also be measured in ° Brix, rather than percentage, and thus the present disclosure includes the total soluble solids content for cherries suitable for processing as approximately 10.5 to 16° Brix. In certain aspects of the invention, the total soluble solids content may be approximately 10.5°, 11.0°, 12.0°, 13.0°, 14.0°, 15.0°, 16.0° Brix, or any value therebetween or greater.

In certain aspects of the invention, the fruit firmness for cherries suitable for processing is approximately 4.0 N to 7.5 N. In certain aspects of this embodiment, the fruit firmness for cherries suitable for processing is approximately 4.0 N, 4.5 N, 5.0 N, 5.5 N, 6.0 N, 6.5 N, 7.0 N, 7.5 N or any value therebetween. In certain aspects of the invention, the pH of cherries suitable for processing may be approximately 3.0 to 5.0. In certain aspects of the invention, the pH of cherries suitable for processing may be approximately 3.0, 3.5, 4.0, 4.5, 5.0, or any value therebetween.

One of skill in the art would recognize that other factors may also be considered when determining the quality control of cherries or other fruit or vegetable that is suitable for processing.

The processed fruit or vegetable products disclosed herein may be used for direct human or animal consumption, or may be processed for cakes, cookies, breads, crackers, cereals, other baked goods, cake mixes, jams, jellies, yogurt mixes, doughnuts, pie fillings, or other food add-ins or other processed food(s).

In at least one embodiment, the fruit is not a pome fruit. In at least one embodiment, the fruit is not an apple. In at least one embodiment, the fruit is not a pear. In at least one embodiment, the fruit or vegetable is not a tomato.

### Packaging and Storing

At least one embodiment of the present invention also relates to a method for packaging and/or storing the processed fruit and/or vegetable products. In one embodiment, the processed fruit or vegetable products are vacuum packed in a container. In the same or a different embodiment, the processed fruit or vegetable products are sealed in cans, jars or plastic cups. In the same or a different embodiment, the processed fruit or vegetable products are packaged in a modified or controlled atmosphere container. Such modified or controlled atmosphere may comprise elevated carbon dioxide levels, elevated nitrogen levels, reduced oxygen levels, reduced ethylene levels, or any combination thereof.

The present invention also relates to storing the processed fruit or vegetables prior to or subsequent to packaging. In one particular embodiment, the processed fruit or vegetables are stored prior to packaging. In another particular embodiment, the processed fruit or vegetables are stored subsequent to packaging. In one embodiment, the fruit or vegetables are stored and/or packaged prior to processing.

In one embodiment, the uncut fruit or vegetables are stored in an environment with a temperature range of 30-80° F. prior to cutting or comminuting. In another particular embodiment, the uncut fruit or vegetables are stored in an environment with a temperature range of 30-53° F. In another embodiment, the uncut fruit or vegetables are stored in an environment with a relative humidity range of 85-95%.

At least one embodiment includes compositions comprising processed fruit and/or vegetable products that have a shelf-life of up to 14 days, 21 days, 30 days, 40 days, 60 days, 75 days, 90 days, 100 days, 110 days, 120 days, 150 days, 180 days, 200 days, 225 days, or any number therebetween or greater. One embodiment of the presently claimed invention includes harvesting, processing and packaging the fruit and/or vegetables all within 1 to 7 days. One embodiment of the presently claimed invention includes harvesting, possibly processing, and packaging the fruit and/or vegetables all within one month to one year.

### System

At least one embodiment disclosed herein relates to an automated system for processing fruits and/or vegetables into products and optionally packaging said products and further optionally transporting the products from the place of processing to a place of packaging (if product is packaged) and further optionally to a place of sale to the consumer. In at least one embodiment, the fruit(s) or vegetable(s) are first transported from a truck, dock, or other carrier to the place of processing. In another embodiment, the system further comprises transporting the fruit from an orchard, greenhouse or other growing facility to the place of processing. The place of processing includes the place of cutting, mashing, splitting, pulverizing or comminuting the fruit(s) or vegetable(s) such that they are reduced to particulate matter or product. Subsequently, the particulate matter or product may be contacted with one or more additives, including a flavoring agent, a coloring agent, a sweetener or sweetening agent, a preservative or anti-browning agent, a micronutrient or a macronutrient.

In one particular embodiment, the system further comprises packaging the processed fruit or vegetable products. In another particular embodiment, the system further comprises unloading the fruits or vegetables from a truck, dock or other carrier. Thus, the system may be located at a main processing facility that is capable of handling multiple fruits and/or vegetables and/or various fruits and/or vegetables.

In another particular embodiment, the system further comprises transporting the fruits or vegetables from an orchard, field, greenhouse or other growing facility to the processing facility. Thus, the system may be located in the orchard, field, greenhouse or other growing facility or the system may be located away from the growing facility.

In one particular embodiment, the system is regulated, operated or controlled by a computer system. In one particular embodiment, at least part of the computer system is remote from the rest of the automated fruit and vegetable processing system. In another particular embodiment, information contained on or in the fruit or vegetable may be entered into the computer and used for tracking the fruit or vegetable through the processing and/or packaging steps.

### Business Methods

At least one embodiment of the present invention further relates to a business method comprising processing the fruits or vegetables into products, supplementing the fruit or vegetable products with one or more additives, packaging said fruit or vegetable products, and selling said supplemented fruit or vegetable products. In a further embodiment, the business method comprises the step of storing said fruits or vegetables after harvest and prior to processing into products.

In another particular embodiment, the invention comprises the step of a company licensing rights from another organization to market or sell the processed fruit or vegetable products. In another particular embodiment, the step of marketing or selling the fruit or vegetable products comprises an organization collecting royalties from a company that sells the fruit or vegetable products. The invention further comprises the step of storing and/or tracking fruit or vegetables after harvest and prior to processing. In another particular embodiment, the invention further comprises the step of collecting fees from a company that sells the fruit or vegetable products. In one particular embodiment, the fees comprise at least one of license fees or milestone fees.

In another particular embodiment, a company licenses or acquires the rights to market or sell the processed fruit or vegetable products and the company identifies another product formulation. In one particular embodiment, the product formulation is a marketed flavoring. In another particular embodiment, the product formulation is off patent.

The present invention further comprises the step of patenting the newly-identified product formulation or method of using the product formulation for the processed fruit or vegetable products.

In any of the aforementioned business methods, the company may be a wholesale or retail grocery, a franchise chain, a theme park, a restaurant, a fast food restaurant, a food processing or manufacturing plant, or any combination thereof. In any of the aforementioned business methods, the organization may be a packer owned orchard, a privately held orchard, a grower-owned field or garden plot, a corporate or agribusiness field, a fruit or vegetable cooperative, or any combination thereof. In any one of the aforementioned business methods, the fruits or vegetables may be derived from one single grower, or the fruits and vegetables may be derived from multiple growers. In any one of the aforementioned business methods, the processed fruit or vegetable products may be exported from the United States.

Certain embodiments further relate to business methods comprising the step of storing the processed fruit or vegetable products subsequent to canning or packaging. Other embodiments further relate to business methods comprising storing the uncut fruit or vegetables prior to processing.

The present invention also relates to a business method comprising tracking the fruit or vegetables through the processing and/or packaging steps. In another embodiment, the business method further comprises tracking the fruit or vegetables from an orchard, greenhouse or other growing facility, through the processing and/or packaging steps. In another embodiment, the business method comprises tracking the fruit or vegetables through transporting and up to and including delivery to the wholesale or retail seller. In another particular embodiment, the invention comprises tracking the fruit or vegetables up to and including consumer purchase. Such method may include the use of a computer to enter, store, access and retrieve information regarding the status of the fruit or vegetables or status of the processing, packaging, and/or transporting steps. A computer used for tracking fruit or vegetables (including the origin of the fruit or vegetables), may be operated by a remote user, such as a human being, another computer or robot.

One of skill in the art would recognize that a variety of types of tracking devices might be employed with embodiments disclosed herein. In particular, radio frequency tags, bar codes or other identifying marks or information may be used to track fruit or vegetables from the orchard, field, greenhouse or other growing facility all the way up to and including the consumer purchase. Such identifying marks or information may be physically contained on the fruit or vegetable itself, contained on the tree, branch, or other growing receptacle where the fruit originated, and may be transferred to a packaging label or entered into a computer tracking system. Identifying marks may include a chemical or color tattoo, a laser etching, a burn mark or brand, or other color mark, a sticker or label, or other informational tag.

### Process for Manufacture

At least one embodiment disclosed herein relates to a process for manufacturing processed fruit or vegetable products, supplementing the products with at least one additive, and packaging said products, thereby manufacturing said processed fruit or vegetable products. For purposes of practicing this particular aspect of the presently claimed invention, the fruit or vegetable is selected from the group consisting of apples, pears, Asian pears, cherries, corn (including cream style corn), beans, carrots, peas, pumpkin, any other fruit or vegetable disclosed herein and any combination thereof (including fruit cocktail). The particular aspects described herein for all other embodiments may likewise be applied to this particular aspect of the invention.

Known methods of processing fruits and/or vegetables for pureed products may be utilized with specific embodiments disclosed herein. The fruit and/or vegetable products may be processed in accordance with good manufacturing process, as set forth in 21 CFR Part 110 of the USDA guidelines, and may be commercially ready to use. Such products may meet the requirements for Grade A, Grade B, or other grades according to the USDA guidelines. In certain embodiments, the fruit or vegetable products may not be more than 90 days old prior to delivery to the place of sale or to the consumer.

Typically, fruit and vegetables suitable for processing are canned or frozen (or dried or dehydrated) quickly in order to preserve their nutritive quality. Most of the processing is usually done by automated equipment, which provides high-speed processing and sanitary, wholesome products preserved with good flavor and quality.

In one exemplary embodiment, preparing fresh fruits or vegetables for processing may include sorting into sizes by hand or machine, washing the produce by continuously circulating water, sprays of water or diluted bleach or other cleaners, and possibly peeling the produce. In some embodiments, the produce may be peeled and/or cut prior to further processing (for sliced, diced, quartered, julienne, or other cut products).

Once the fruits and/or vegetables are peeled and/or cut, they may be heated and/or mixed with additives disclosed herein. The mixture of fruit and/or vegetable product(s) may then be transferred to containers, such as cans or jars. In some embodiments, the containers may be filled by automatic or semi-automatic means, including conveyor belts. Once the containers are filled, they may be heat-sealed, regular packed, solid packed, vacuum packed, or otherwise sealed or packed.

By contrast, in certain embodiments the containers may be filled first with the peeled and/or cut produce, sealed and then heated under controlled conditions of time and temperature.

The containers may be cooled deliberately by cold gas or liquid cooling, or they may be air-cooled. Once the containers are cooled, they are stored in a cool, dry, well-ventilated warehouse until shipment to market.

Still in other embodiments, the fruits and/or vegetables may be blanched and then frozen. Blanching involves a heat treatment of foodstuffs for a sufficient time and at a sufficient temperature to partially or completely inactivate the naturally occurring enzymes and to effect other physical or biochemical changes in the food. Blanching ensures that the product will retain much of its natural appearance, flavor, and nutrition. After freezing, the products may be packaged in containers (bags, or the like).

Thus, the additives disclosed herein may be contacted with the fruit and/or vegetable puree or pulp at numerous times during production. Depending on the particular embodiment, all of the additives of a particular product may be introduced at a single time during production, or at multiple times during production. Further, the same or different additives may be introduced at the same or different time points during production. Of course, one of skill in the art would understand that, depending on the additive, there may be preferable time points for introduction for one or more additive (depending on temperature sensitivity of the additive, for example). For example, if a particular additive (such as a vitamin) is heat-sensitive, the vitamin may be added once the product is cooled, or may be added in such a way that the integrity of the vitamin (or other additive) is maintained.

As another example, one or more additives may be placed in contact with the processed fruit and/or vegetables at the same time or subsequent to cleaning the fruits or vegetables. In another exemplary embodiment, one or more additives may be placed in contact with the processed fruit and/or vegetables at the same time or subsequent to comminuting the fruit and/or vegetables. In still another exemplary embodiment, one or more additives may be placed in contact with the processed fruit and/or vegetables at the same time or subsequent to heating, freezing, drying, dehydrating, mixing, or otherwise altering the fruits and/or vegetables in size, shape or form. In still other embodiments, the fruit and/or vegetable product may be contacted with one or more additive upon canning, freezing, or otherwise packaging.

The following examples are offered by way of illustration and not by way of limitation of the invention. It is understood that the examples and embodiments described herein are for illustrative purposes only and that various modifications or changes in light thereof will be suggested to persons skilled in the art and to be included within the scope and spirit of the invention.

All of the U.S. patents, U.S. patent application publications, U.S. patent applications, foreign patents, foreign patent applications and non-patent publications referred to in this specification and/or listed in the Application Data Sheet are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A composition comprising a pureed fruit or vegetable product and an additive selected from the group consisting of flavoring, sweetener, color, vitamins, minerals and a macronutrient.

2. The composition of claim 1 wherein said vitamin is selected from the group consisting of vitamin C, folic acid, vitamin D, and vitamin E.

3. The composition of claim 1 wherein said mineral is selected from the group consisting of iron, calcium and magnesium.

4. The composition of claim 1 wherein said macronutrient is selected from the group consisting of fatty acids, oil, protein, and amino acids.

5. The composition of claim 4 wherein said macronutrient is from the source of flaxseed oil.

6. The composition of claim 1 wherein said flavor is selected from the group consisting of apple, chocolate, rum, triple sec, peppermint, ginger, orange, lemon, lime, blueberry, blackberry, strawberry, margarita, pina colada, daiquiri, cherry, root beer, butterscotch, peanut butter, vodka, gin, whiskey, brandy, cheese, wine flavors (such as merlot, cabernet, chardonnay, etc.), smoked, barbeque, chipotle, ranch, curry, vanilla, mint, cinnamon, apple pie, raspberry, maple, grape, cola, caramel, mango, kiwi, English Toffee, cocoa, tropical flavors, bubble gum, peach, coconut, bergamot, cinnamon bark, ginger ale, grapefruit, lemon-lime, mandarin, sweet orange, triple sec, almond butter, butter pecan, coffee, cream, honey, peanut, guava, amaretto, Asian Blender, Crème de Menthe, Kalamansi, Sloe berry, Chai Tea, Tequila, white strawberry, white cranberry, ginger, white grape, guarana, jasmine, malted milk, mint, orange juice, orange sherbet, Oriental Herbal, punch, sugar, tropical fruit, Chichamorada, Cherimoya, Ginseng mint, melon, papaya, Ming Tea, Sweet Musk melon, pandan, tamarind, tangerine, strawberry kiwi, guanabana, peach apricot, Apple strudel, chocolate cherry, chocolate mint, French vanilla, licorice, minty melon, Amaretto, chocolate fudge, green bell pepper, Muscat, baby powder, Boston Crème, cantaloupe, cheesecake, chocolate hazelnut, cologne, hazelnut, pine oil, pizza, sesame oil, pumpkin spice, rose, brown sugar, sweet roll, tropical punch, vanilla cream, Bleu Cheese, melted butter, sweet butter, roasted chicken, milk chocolate, toasted coconut, ginger snap, graham cracker, mushroom, pecan, pistachio, red raspberry, blue raspberry, strudel, wafer, walnut, Royal cream, sour cream, dry apricot, caramel corn, cotton candy, cranapple, Temple orange, fresh pineapple, black raspberry, fresh strawberry, passion fruit, wildberry, orange cream, sweet cherry, banana, mango, wild raspberry, wild blueberry, wild blackberry, root beer cream, cola cream, carrot, carrot cake, pumpkin, “buttery” versions of any flavors described herein, any flavors described herein with cinnamon or extra cinnamon or other spice, or any combination thereof.

7. The composition of claim 1 wherein said sweetener is selected from the group consisting of: white cane sugar or syrup, brown sugar or syrup, dextrose, glucose, lactose, whey, ribose, xylose, xylitol, rhamnose, date sugar, white or brown rice syrup, malt, molasses or molasses powder, honey, dehydrated honey, corn syrup or corn syrup solids, maple syrup, high fructose corn syrup, fructose, saccharin, Splenda™ (sucralose), NutraSweet™ (aspartame), acesulfame-K, stevia, Shugr™ (a mixture of erythritol, maltodextrin and sucralose), any modification of these sweeteners, any combination thereof, and the like.

8. The composition of claim 1 wherein said fruit or vegetable is selected from the group consisting of apples, pears, Asian pears, cherries, strawberries, plums, peaches, nectarines, grapes, melons guava, dates, figs, apricots, kiwi, lemons, limes, grapefruit, oranges, tangelos, kumquats, ugli fruit, mandarin oranges, Satsuma oranges, mango, bananas, passion fruit, pineapple, cranberries, blueberries, blackberries, papaya, coconut, jackfruit, tomatoes, lettuce, spinach, Swiss chard, potatoes, carrots, beans, and corn.

9. The composition of claim 1 wherein said fruit or vegetable comprises apples.

10. The composition of claim 1 wherein said fruit or vegetable product comprises applesauce.

11. The composition of claim 10 wherein said fruit or vegetable product comprises applesauce, and said additive comprises at least flaxseed oil and protein.

12. A method of making a processed fruit or vegetable product comprising comminuting a fruit or vegetable into particulate matter, contacting said fruit or vegetable matter with at least one additive selected from the group consisting of flavoring agent, coloring agent, preservative, vitamins, minerals, and macronutrients.

13. The method of claim 12 wherein said fruit or vegetable is selected from the group consisting of apples, pears, Asian pears, cherries, strawberries, plums, peaches, nectarines, grapes, melons guava, dates, figs, apricots, kiwi, lemons, limes, grapefruit, oranges, tangelos, kumquats, ugli fruit, mandarin oranges, Satsuma oranges, mango, bananas, passion fruit, pineapple, cranberries, blueberries, blackberries, papaya, coconut, jackfruit, tomatoes, lettuce, spinach, Swiss chard, potatoes, carrots, beans, and corn.

14. The method of claim 12 wherein said flavoring agent is selected from the group consisting of apple, chocolate, rum, triple sec, peppermint, ginger, orange, lemon, lime, blueberry, blackberry, strawberry, margarita, pina colada, daiquiri, cherry, root beer, butterscotch, peanut butter, vodka, gin, whiskey, brandy, cheese, wine flavors (such as merlot, cabernet, chardonnay, etc.), smoked, barbeque, chipotle, ranch, curry, vanilla, mint, cinnamon, apple pie, raspberry, maple, grape, cola, caramel, mango, kiwi, English Toffee, cocoa, tropical flavors, bubble gum, peach, coconut, bergamot, cinnamon bark, ginger ale, grapefruit, lemon-lime, mandarin, sweet orange, triple sec, almond butter, butter pecan, coffee, cream, honey, peanut, guava, amaretto, Asian Blender, Crème de Menthe, Kalamansi, Sloe berry, Chai Tea, Tequila, white strawberry, white cranberry, ginger, white grape, guarana, jasmine, malted milk, mint, orange juice, orange sherbet, Oriental Herbal, punch, sugar, tropical fruit, Chichamorada, Cherimoya, Ginseng mint, melon, papaya, Ming Tea, Sweet Musk melon, pandan, tamarind, tangerine, strawberry kiwi, guanabana, peach apricot, Apple strudel, chocolate cherry, chocolate mint, French vanilla, licorice, minty melon, Amaretto, chocolate fudge, green bell pepper, Muscat, baby powder, Boston Crème, cantaloupe, cheesecake, chocolate hazelnut, cologne, hazelnut, pine oil, pizza, sesame oil, pumpkin spice, rose, brown sugar, sweet roll, tropical punch, vanilla cream, Bleu Cheese, melted butter, sweet butter, roasted chicken, milk chocolate, toasted coconut, ginger snap, graham cracker, mushroom, pecan, pistachio, red raspberry, blue raspberry, strudel, wafer, walnut, Royal cream, sour cream, dry apricot, caramel corn, cotton candy, cranapple, Temple orange, fresh pineapple, black raspberry, fresh strawberry, passion fruit, wildberry, orange cream, sweet cherry, banana, mango, wild raspberry, wild blueberry, wild blackberry, root beer cream, cola cream, carrot, carrot cake, pumpkin, “buttery” versions of any flavors described herein, any flavors described herein with cinnamon or extra cinnamon or other spice, or any combination thereof.

15. The method of claim 12 wherein said preservative is selected from the group consisting of citric acid; NatureSeal™; vitamin(s); mineral(s); ascorbic acid; potassium sorbate; enzymes; acids; bases; erythorbic acid; calcium; sulfur dioxide; sulfites; benzoic acid; Freshxtend™, a blend of vitamins and minerals, other antioxidants such as butylated hydroxyanisole (BHA), butylated hydroxytoluene (BHT), tert-butylhydroquinone (TBHQ), propyl gallate, ascorbyl palmitate; or any combination thereof.

16. The method of claim 12 wherein said vitamin is selected from the group consisting of vitamin A, vitamin B1, vitamin B2, vitamin B3, vitamin B5, vitamin B6, vitamin B7, vitamin B8, vitamin H, vitamin B9, vitamin B10, vitamin B12, vitamin B13, vitamin B15, vitamin B17, vitamin C, vitamin P, vitamin D, vitamin E, and vitamin K.

17. The method of claim 12 wherein said mineral is selected from the group consisting of: chromium, copper, fluorine, manganese, lycopene, lutein, selenium, zinc, inositol, calcium, chlorine, magnesium, phosphorus, potassium, sodium, sulfur, cobalt, iodine, iron, molybdenum, bismuth, boron, nickel, rubidium, silicon, strontium, tellurium, titanium, tin, tungsten, and vanadium.

18. The method of claim 12 further comprising packaging said fruit or vegetable product.
